(19) United States
(12) Patent Application Publication
(10) Pub. No.: US 2019/0027078 A1
(43) Pub. Date: Jan. 24, 2019

(54) LOW POWER CONSUMPTION INTELLIGENT DISPLAY DEVICE AND METHOD FOR DISPLAY THEREOF

(71) Applicant: Wuhan China Star Optoelectronics Technology Co., Ltd., Wuhan, Hubei (CN)

(72) Inventor: Qingcheng ZUO, Wuhan, Hubei (CN)

(21) Appl. No.: 15/571,006

(22) PCT Filed: Oct. 19, 2017
(86) PCT No.: PCT/CN2017/106881

§ 371 Date: Oct. 31, 2017

(30) Foreign Application Priority Data
Jul. 24, 2017 (CN) 201710608546.9

(51) Int. Cl. G09G 3/20; G06F 3/041

(52) U.S. Cl. CPC G09G 3/20; G06F 3/0416; G09G 2340/0407; G09G 2354/00; G09G 2310/04; G09G 2330/021

(57) ABSTRACT

The present application relates to a low power consumption intelligent display device and a method for display thereof. The display device includes a touch display module, a driving module and a system module. The driving module includes a display driving module and a touch driving module. When the touch driving module detects the occurrence of a finger touch, the coordinate is feedback to the system module, the system module determines the focusing and the non-focusing regions of the human eyes in accordance with the coordinate of the touch; the system module reduces the amount of display data per unit time corresponding to the non-focusing region by the system module when generating the display data in accordance with the display image to be displayed; when the touch driving module detects that no finger touch occurs, the system module normally generates display data in accordance with the display image to be displayed.

### FIELD OF THE DISCLOSURE

The disclosure relates to a display technical field, and more particularly to a low power consumption intelligent display device and method for display thereof.

### BACKGROUND

With the development of the display industry, the display panel not only has a development from the initial dot matrix to today's liquid crystal display, OLED, etc., but the liquid crystal display is also from black and white display to color display; and in the field of display devices, such as mobile phone display, the display size is also from less than 1 inch develop to today's 5-inch, 6-inch or even greater. As shown in FIG. 1, it is the illustration diagram of the image quality requirements when the human eyes are focused. When the display module 11 is viewed by the human eyes, the display module 11 can be divided into a focusing region and a non-focusing region in accordance with a human eyes focusing region, the definition requirement of the focusing region is high, and the definition requirement of the non-focusing region is low. The division of the focusing region and the non-focusing region can be predetermined. In FIG. 1 is taking a more simple way for the division, the region where the finger is taking as the focusing region, the display module 11 is left and right divided into the focusing region and the non-focusing region along the dotted line. Taking large-panel mobile phone display as an example, due to the focusing characteristic of the human eyes itself, when viewing the large panel mobile phone display by human, the focusing region of the human is only a partial region of the display panel, rather than the entire display panel, the demand for the display performance of the non-focusing region of the human eyes will be much lower than the demand for the focusing region. How to reduce the display power consumption of large-panel mobile phones under the premise without affecting the display performance is a worthy subject.

Referring to FIG. 2, FIG. 2 is a schematic diagram of a basic architecture of a conventional display device. The conventional display device mainly includes a touch display module 21, a driving module 22 and a system module 23. The touch display module 21 is connected to the driving module 22, the driving module 22 is connected to the system module 23. The driving module 22 mainly includes a display driving module 221 and a touch driving module 222, the display driving module 221 drives the touch display module 21 to perform the display in accordance with the display data generated by the system module 23, the touch driving module 222 drives the touch display module 21 to detect the touch position information and feedback the touch position information to the system module 23. Taking the conventional mobile phone as an example, the system module 23 is a mobile phone system terminal, the touch driving module 222 is a touch chip (IC), the display driving module 221 is a display chip, the touch display module 21 is a mobile touch display panel, the mobile phone system terminal generates a display data corresponding to a display image with 1440*2560 resolution in RGB mode, the display chip drives the phone touch panel to display the display image with 1440*2560 resolution in RGB mode in accordance with the display data, when the touch IC detects a finger touching the phone touch panel, the coordinate of the touch occurred is feedback to the phone system terminal, both the touch region and the untouched region are displayed in high quality without optimizing power consumption.

### SUMMARY

Therefore, an object of the present application is to provide a low power consumption intelligent display device to reduce the power consumption of a display device with large display panel without affecting the display performance.

The other object of the present application is to provide a method for display a low power consumption intelligent display device to reduce the power consumption of a display device with large display panel without affecting the display performance.

In order to achieve the above object, the present application provides a low power consumption intelligent display device including: a touch display module, a driving module and a system module; the touch display module connected to the driving module, the driving module connected to the system module, the driving module comprising a display driving module and a touch driving module; the system module generating a display data in accordance with a display image to be displayed, the display driving module driving the touch display module to perform display in accordance with the display data generated by the system module, the touch driving module driving the touch display module to detect a touch position information and feedback the touch position information to the system module; when the touch driving module detecting an occurrence of a finger touch, a coordinate of the touch occurred feedback to the system module, the system module determining a focusing region and a non-focusing region of the human eyes in accordance with the coordinate of the occurrence of the finger touch, the system module reducing the amount of the display data per unit time corresponding to the non-focusing region when generating the display data in accordance with the display image to be displayed; and when the touch driving module detecting no occurrence of the finger touch, the system module normally generating the display data in accordance with the display image to be displayed.

Wherein the reducing the amount of the display data per unit time corresponding to the non-focusing region is stopping an update of the display data corresponding to the non-focusing region.

Wherein the reducing the amount of the display data per unit time corresponding to the non-focusing region is reducing a definition of the display image corresponding to the non-focusing region.

Wherein the reducing the amount of the display data per unit time corresponding to the non-focusing region is reducing an update frequency of the display data corresponding to the non-focusing region.

Wherein the reducing the amount of the display data per unit time corresponding to the non-focusing region is reducing a grayscale of the display data corresponding to the non-focusing region.

The present application further provides a method for display a low power consumption intelligent display device, including:

Step 10, when a touch driving module detecting an occurrence of a finger touch, a coordinate of the occurrence of the touch being feedback to a system module, the system module determining a focusing region and a non-focusing region of human eyes in accordance with the coordinate of the occurrence of the finger touch;

Step 20, reducing an amount of display data per unit time corresponding to the non-focusing region by the system module when generating the display data in accordance with a display image to be displayed; and

Step 30, when the touch driving module detecting no occurrence of the finger touch, the system module normally generating the display data in accordance with the display image to be displayed.

Wherein the reducing the amount of the display data per unit time corresponding to the non-focusing region is stopping an update of the display data corresponding to the non-focusing region.

Wherein the reducing the amount of the display data per unit time corresponding to the non-focusing region is reducing a definition of the display image corresponding to the non-focusing region.

Wherein the reducing the amount of the display data per unit time corresponding to the non-focusing region is reducing an update frequency of the display data corresponding to the non-focusing region.

Wherein the reducing the amount of the display data per unit time corresponding to the non-focusing region is reducing a grayscale of the display data corresponding to the non-focusing region.

The present application further provides a low power consumption intelligent display device, including: a touch display module, a driving module and a system module; the touch display module connected to the driving module, the driving module connected to the system module, the driving module including a display driving module and a touch driving module; the system module generating a display data in accordance with a display image to be displayed, the display driving module driving the touch display module to perform display in accordance with the display data generated by the system module, the touch driving module driving the touch display module to detect a touch position information and feedback the touch position information to the system module; when the touch driving module detecting an occurrence of a finger touch, a coordinate of the touch occurred feedback to the system module, the system module determining a focusing region and a non-focusing region of the human eyes in accordance with the coordinate of the occurrence of the finger touch, the system module reducing the amount of the display data per unit time corresponding to the non-focusing region when generating the display data in accordance with the display image to be displayed; when the touch driving module detecting no occurrence of the finger touch, the system module normally generating the display data in accordance with the display image to be displayed;

Wherein the reducing the amount of the display data per unit time corresponding to the non-focusing region is stopping an update of the display data corresponding to the non-focusing region;

Reducing a definition of the display image corresponding to the non-focusing region;

Reducing an update frequency of the display data corresponding to the non-focusing region; or

Reducing a grayscale of the display data corresponding to the non-focusing region.

In summary, the low power consumption intelligent display device and the method for display thereof of the present application can reduce the power consumption of the display device with large display panel without affecting the display performance.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings in accordance with these drawings without creative efforts. In the figures:

FIG. 1 is an illustration diagram of the image quality requirements when the human eyes is focused;

FIG. 2 is a schematic diagram of a basic architecture of a conventional display device; and

FIG. 3 is a schematic diagram of a basic architecture of a preferred embodiment of the low power consumption intelligent display device of the present application.

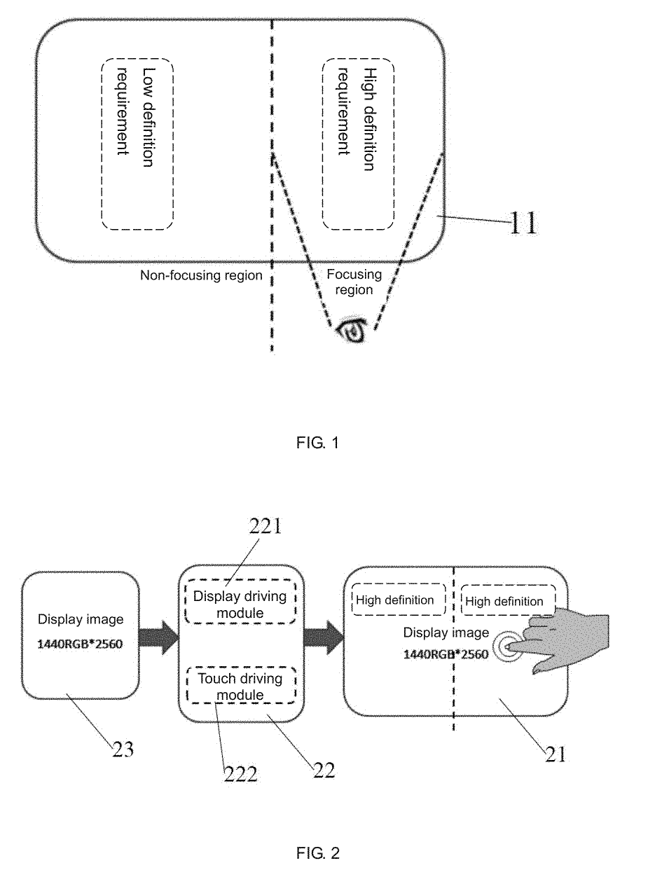

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

In the description of the disclosure, terms such as “center”, “transverse”, “above”, “below”, “left”, “right”, “vertical”, “horizontal”, “top”, “bottom”, “inside”, “outside”, etc. for indicating orientations or positional relationships refer to orientations or positional relationships as shown in the drawings; the terms are for the purpose of illustrating the disclosure and simplifying the description rather than indicating or implying the device or element must have a certain orientation and be structured or operated by the certain orientation, and therefore cannot be regarded as limitation with respect to the disclosure. Moreover, terms such as “first” and “second” are merely for the purpose of illustration and cannot be understood as indicating or implying the relative importance or implicitly indicating the number of the technical feature. Therefore, features defined by “first” and “second” can explicitly or implicitly include one or more the features. In the description of the disclosure, unless otherwise indicated, the meaning of “plural” is two or more than two. In addition, the term “comprise” and any variations thereof are meant to cover a non-exclusive inclusion.

In the description of the disclosure, is should be noted that, unless otherwise clearly stated and limited, terms “mounted”, “connected with” and “connected to” should be understood broadly, for instance, can be a fixed connection, a detachable connection or an integral connection; can be a mechanical connection, can also be an electrical connection; can be a direct connection, can also be an indirect connection by an intermediary, can be an internal communication of two elements. A person skilled in the art can understand concrete meanings of the terms in the disclosure as per specific circumstances.

The terms used herein are only for illustrating concrete embodiments rather than limiting the exemplary embodiments. Unless otherwise indicated in the content, singular forms “a” and “an” also include plural. Moreover, the terms “comprise” and/or “include” define the existence of described features, integers, steps, operations, units and/or components, but do not exclude the existence or addition of one or more other features, integers, steps, operations, units, components and/or combinations thereof.

The disclosure will be further described in detail with reference to accompanying drawings and preferred embodiments as follows.

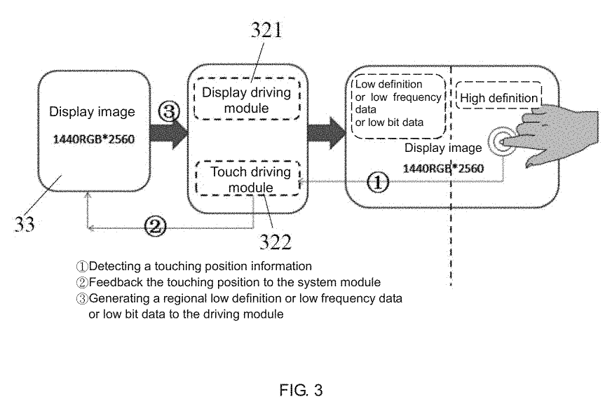

Referring to FIG. 3, FIG. 3 is a schematic diagram of a preferred embodiment of a low power consumption intelligent display device of the present application. The low power consumption intelligent display device of the present application mainly includes: a touch display module 31, a driving module 32 and a system module 33, the touch display module 31 is connected to the driving module 32, the driving module 32 is connected to the system module 33. The driving module 32 includes: a display driving module 321 and a touch driving module 322; the system module 33 generates display data in accordance with the display image to be displayed, the display driving module 321 drives the touch display module 31 to perform display in accordance with the display data generated by the system module 33, the touch driving module 322 drives the touch display module 31 to detect the touch position information and feedback the touch position information to the system module 33; when the touch driving module 322 detects that a finger touch has occurred, the coordinate of the touch occurred is feedback to the system module 33, the system module 33 determines the focusing region and the non-focusing region of the human eyes in accordance with a coordinate of an occurrence of a finger touch, and the system module 33 reduces the amount of the display data per unit time corresponding to the non-focusing region when generating the display data in accordance with the display image to be displayed; when the touch driving module 322 detects that no finger touch is occurred, the system module 33 normally generates the display data in accordance with the display image to be displayed.

The present application is described in detail with reference to a large panel mobile phone, the system module 33 may be a mobile phone system terminal, the touch driving module 322 may be a touch chip, the display driving module 321 may be a display chip, the touch display module 31 may be a mobile phone touch display panel, the phone system terminal generates a display data corresponding to a display image with 1440*2560 resolution in RGB mode, the display chip drives the phone touch panel to display the display image with 1440*2560 resolution in RGB mode in accordance with the display data, when the touch IC detects a finger touch is occurred in the phone touch panel, the coordinate of the touch occurred is feedback to the phone system terminal. In the preferred embodiment, the division way of the focusing region and the non-focusing region may be predetermined. In FIG. 3 is taking a more simple way for the division, the region where the finger is taking as the focusing region, the display module 31 is left and right divided into the focusing region and the non-focusing region along the dotted line. It can also use the upper and lower division or other suitable division way.

When the touch IC detects that no finger touch is occurred, the mobile phone system terminal performs the normal data updating. Corresponding to the display image with 1440*2560 resolution in RGB mode to be displayed, the mobile phone system terminal generates display data in accordance with the normal way and provides to the display chip for driving the phone touch display panel to display high quality display of the display image with 1440*2560 resolution in RGB mode.

When the touch IC detects a finger touch is occurred, the coordinate of the touch occurred will be feedback to the mobile phone system. The mobile phone system judges the focusing region of the human eyes in accordance with the coordinate. When the system terminal obtains the touch occurring region, it determines the range of the region is the focusing region of the human eyes (in accordance with the characteristics when the finger is touched, the human eyes is synchronously focusing on the location of the touch), the resolution requirement of the region for the display data is higher, the display data need to be normally updated; and the other region not focused by the human eyes, the resolution requirement for the display data is lower, the display data does not need to be updated or maintain in a lower frequency to be updated.

It is within the protection scope of the present application for various display devices having a finger touch or other touch device and the display devices for reducing the amount of data displayed per unit time in accordance with the touch position to reduce the power consumption. The ways of reducing the amount of data displayed per unit time corresponding to the non-focusing region include:

Stopping an update of the display data corresponding to the non-focusing region;

Reducing a definition of the display image corresponding to the non-focusing region, for example, reducing the brightness;

Reducing an update frequency of the display data corresponding to the non-focusing region, that is, the display data of the non-focusing region is low frequency data;

Reducing a grayscale of the display data corresponding to the non-focusing region, that is, the display data of the non-focusing region is low bit data.

The present application is applicable to the LCD display industry, and more particularly to a novel low power consumption intelligent display device reducing the definition or frequency or bit number of partial image in accordance with the touch position.

The present application also provides a method for display the corresponding low power consumption intelligent display device, including:

Step 10, when a touch driving module detecting an occurrence of a finger touch, a coordinate of the occurrence of the touch being feedback to a system module, the system module determining a focusing region and a non-focusing region of human eyes in accordance with the coordinate of the occurrence of the finger touch;

Step 20, reducing an amount of display data per unit time corresponding to the non-focusing region by the system module when generating the display data in accordance with a display image to be displayed;

Step 30, when the touch driving module detecting no occurrence of the finger touch, the system module normally generating the display data in accordance with the display image to be displayed.

The method is described below with reference to the large panel mobile phone. For step 10, when the touch IC detects the occurrence of the finger touch, and feedback the coordinate of the touch occurred to the mobile phone system terminal, the mobile phone system terminal determines the focusing region of the human eyes in accordance with the coordinate of the finger touch (in accordance with the characteristics when the finger is touched, the human eyes is synchronously focusing on the location of the touch), and further determines the non-focusing region, and the region to be performed the low definition or low frequency data or low bit data update.

For step 20, the resolution requirement for the display data of the focusing region by the human eyes is higher, the display data need to be normally updated; and the other region not focused by the human eyes, the resolution requirement for the display data is lower, the display data does not need to be updated, or maintain in a lower definition, or low frequency data or low bit data to be updated, to save power consumption without affecting the purpose of visual effects.

For step 30, when the touch IC detects that the finger stops touching, the mobile phone system terminal is back to the normal data updating.

In summary, the low power consumption intelligent display device and the method for display thereof of the present application can reduce the power consumption of the large display panel display device without affecting the display performance.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A low power consumption intelligent display device, comprising:
a touch display module, a driving module and a system module; the touch display module connected to the driving module, the driving module connected to the system module, the driving module comprising a display driving module and a touch driving module;
the system module generating a display data in accordance with a display image to be displayed, the display driving module driving the touch display module to perform display in accordance with the display data generated by the system module, the touch driving module driving the touch display module to detect a touch position information and feedback the touch position information to the system module;
when the touch driving module detecting an occurrence of a finger touch, a coordinate of the occurrence of the finger touch being feedback to the system module, the system module determining a focusing region and a non-focusing region of human eyes in accordance with the coordinate of the occurrence of the finger touch, the system module reducing an amount of the display data per unit time corresponding to the non-focusing region when generating the display data in accordance with the display image to be displayed; and
when the touch driving module detecting no occurrence of the finger touch, the system module normally generating the display data in accordance with the display image to be displayed.

2. The low power consumption intelligent display device according to claim 1, wherein the reducing the amount of the display data per unit time corresponding to the non-focusing region is stopping an update of the display data corresponding to the non-focusing region.

3. The low power consumption intelligent display device according to claim 1, wherein the reducing the amount of the display data per unit time corresponding to the non-focusing region is reducing a definition of the display image corresponding to the non-focusing region.

4. The low power consumption intelligent display device according to claim 1, wherein the reducing the amount of the display data per unit time corresponding to the non-focusing region is reducing an update frequency of the display data corresponding to the non-focusing region.

5. The low power consumption intelligent display device according to claim 1, wherein the reducing the amount of the display data per unit time corresponding to the non-focusing region is reducing a grayscale of the display data corresponding to the non-focusing region.

6. A method for display a low power consumption intelligent display device according to claim 1, comprising:
Step 10, when a touch driving module detecting an occurrence of a finger touch, a coordinate of the occurrence of the finger touch being feedback to a system module, the system module determining a focusing region and a non-focusing region of human eyes in accordance with the coordinate of the occurrence of the finger touch;
Step 20, reducing an amount of display data per unit time corresponding to the non-focusing region by the system module when generating the display data in accordance with a display image to be displayed; and
Step 30, when the touch driving module detecting no occurrence of the finger touch, the system module normally generating the display data in accordance with the display image to be displayed.

7. The method for display a low power consumption intelligent display device according to claim 6, wherein the reducing the amount of the display data per unit time corresponding to the non-focusing region is stopping an update of the display data corresponding to the non-focusing region.

8. The method for display a low power consumption intelligent display device according to claim 6, wherein the reducing the amount of the display data per unit time corresponding to the non-focusing region is reducing a definition of the display image corresponding to the non-focusing region.

9. The method for display a low power consumption intelligent display device according to claim 6, wherein the reducing the amount of the display data per unit time corresponding to the non-focusing region is reducing an update frequency of the display data corresponding to the non-focusing region.

10. The method for display a low power consumption intelligent display device according to claim 6, wherein the reducing the amount of the display data per unit time corresponding to the non-focusing region is reducing a grayscale of the display data corresponding to the non-focusing region.

11. A low power consumption intelligent display device, comprising:
a touch display module, a driving module and a system module; the touch display module connected to the driving module, the driving module connected to the system module, the driving module comprising a display driving module and a touch driving module;
the system module generating a display data in accordance with a display image to be displayed, the display driving module driving the touch display module to perform display in accordance with the display data generated by the system module, the touch driving module driving the touch display module to detect a touch position information and feedback the touch position information to the system module;
when the touch driving module detecting an occurrence of a finger touch, a coordinate of the occurrence of the finger touch being feedback to the system module, the system module determining a focusing region and a non-focusing region of human eyes in accordance with the coordinate of the occurrence of the finger touch, the system module reducing an amount of the display data per unit time corresponding to the non-focusing region when generating the display data in accordance with the display image to be displayed;
when the touch driving module detecting no occurrence of the finger touch, the system module normally generating the display data in accordance with the display image to be displayed; and
wherein the reducing the amount of the display data per unit time corresponding to the non-focusing region is stopping an update of the display data corresponding to the non-focusing region;
reducing a definition of the display image corresponding to the non-focusing region;
reducing an update frequency of the display data corresponding to the non-focusing region; or
reducing a grayscale of the display data corresponding to the non-focusing region.
